(19) United States
(12) Patent Application Publication
(10) Pub. No.: US 2024/0123577 A1
(43) Pub. Date: Apr. 18, 2024

(54) Compound Actuating Tool

(71) Applicant: Milwaukee Electric Tool Corporation, Brookfield, WI (US)

(72) Inventor: Caleb C. Adams, Milwaukee, WI (US)

(21) Appl. No.: 18/459,996

(22) Filed: Sep. 1, 2023

Related U.S. Application Data
(60) Provisional application No. 63/379,492, filed on Oct. 14, 2022.

(51) Int. Cl. B25B 7/08; B25B 7/12

(52) U.S. Cl. CPC B25B 7/08; B25B 7/12

(57) ABSTRACT

A clamping tool, such as pliers, is provided. The clamping tool includes a pair of components coupled to a pair of jaws. The first component and the first jaw include a first set of teeth that engage with a second set of teeth included in the second component and second jaw. The engagement between the teeth provide a compound leverage system.

### CROSS-REFERENCE TO RELATED PATENT APPLICATION

The present application claims the benefit of and priority to U.S. Provisional Application No. 63/379,492 filed on Oct. 14, 2022, which is incorporated herein by reference in its entirety.

### BACKGROUND OF THE INVENTION

The present disclosure is directed generally to the field of compound actuating tools. The present disclosure relates specifically to compound actuating tools with opposing interfacing surfaces, such as clamping tools (e.g., self-adjusting compound pliers).

Actuating tools with opposing interfacing surfaces, such as pliers, typically include at least one geared mechanism (e.g., a pawl) separate from the handles. Described herein are compound actuating tools, such as pliers, in which two sets of geared teeth are integrated into the handles and/or jaws.

### SUMMARY OF THE INVENTION

One embodiment of the invention relates to pliers including a first jaw with a first interface portion, a first component coupled to the first jaw and a second jaw pivotally coupled to the first jaw. The first component includes a first neck section coupled to the first jaw, a first grip section extending from the first neck section and a first plurality of teeth extending from the first neck section away from the first jaw. The second jaw is rotatable with respect to the first jaw about a first rotational axis. The second jaw includes a second interface portion facing toward the first interface portion and on an opposing side of a longitudinal axis from the first interface portion. The pliers further include a second component. The second component includes a second neck section pivotally coupled to the second jaw, a second grip section extending from the second neck section and a second plurality of teeth extending outward from the second neck section. The second jaw pivotally rotates with respect to the second component about a second rotational axis distinct from the first rotational axis. The pliers include a biasing element coupled to the second component and the second jaw such that the second jaw is moved with the second component. The first jaw and the second jaw actuate between an open position in which the first interface portion and the second interface portion are spaced apart, and a closed position in which the first interface portion contacts the second interface portion. When the second grip section is actuated toward the first grip section, the first plurality of teeth engage the second plurality of teeth.

Another embodiment of the invention relates to clamping tool including a first jaw with a first jaw face, a first component coupled to the first jaw and a second jaw pivotally coupled to the first jaw. The first component includes a first neck section coupled to the first jaw, a first grip section extending from the first neck section and a first plurality of teeth extending from the first neck section. The second jaw is rotatable with respect to the first jaw about a first rotational axis. The second jaw includes a second jaw face position on an opposing side of a longitudinal axis from the first jaw face. The clamping tool further include a second component. The second component includes a second neck section pivotally coupled to the second jaw, a second grip section extending from the second neck section and a second plurality of teeth extending from the second neck section. The second jaw pivotally rotates with respect to the second component about a second rotational axis. The clamping tool includes a biasing element coupled to the second component and the second jaw such that the second jaw and the second component move together. When the first jaw face and the second jaw face are spaced apart, the first plurality of teeth are disengaged from the second plurality of teeth. When the second grip section is rotated toward the longitudinal axis and the first jaw face and the second jaw face engage a workpiece, the first plurality of teeth engage the second plurality of teeth as a torque is applied to the workpiece.

Another embodiment of the invention relates to pliers including a first jaw with a first interface portion, a first component coupled to the first jaw and a second jaw pivotally coupled to the first jaw. The first component includes a first neck section coupled to the first jaw, a first grip section extending from the first neck section and a first plurality of teeth extending from the first neck section away from the first jaw. The second jaw is rotatable with respect to the first jaw about a first rotational axis. The second jaw includes a second interface portion facing toward the first interface portion. The pliers further include a second component. The second component includes a second neck section pivotally coupled to the second jaw, a second grip section extending from the second neck section, a constraining surface facing toward the second grip section, and a second plurality of teeth extending from the second neck section. The second jaw pivotally rotates with respect to the second component about a second rotational axis. The pliers include a spring coupled to the second component and the second jaw. The spring applies a biasing force pushing the second jaw into engagement with the constraining surface of the second component to resist movement of the second component relative to the second jaw.

In various embodiments, the second component includes a first elongate aperture and the second jaw includes a second aperture. The pliers include an elongate structure (e.g., a pin) extending through the first elongate aperture and the second aperture thereby pivotally coupling the second component and the second jaw such that the second component is slidable and pivotally rotatable with respect to the second jaw.

In various embodiments, the elongate aperture extends from a first end closest to the second plurality of teeth to an opposing second end furthest from the second plurality of teeth, and the second plurality of teeth include an outer surface defining a first radius centered on a point that is outside the elongate aperture.

In various embodiments, the elongate aperture defines a first distance from the first end to the tooth in the plurality of teeth closest to the first grip section, and a second distance from the second end to the tooth in the plurality of teeth closest to the first grip section, and the first radius of the outer surface is greater than the first distance and less than the second distance.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a clamping device, according to an exemplary embodiment.

FIG. 2 is a side view of the clamping device of FIG. 1, according to an exemplary embodiment.

FIG. 3 is a side view of the clamping device of FIG. 1, according to an exemplary embodiment.

FIG. 4 is a side view of the clamping device of FIG. 1, according to an exemplary embodiment.

FIG. 5 is a perspective view of a portion of the clamping device of FIG. 1, according to an exemplary embodiment.

FIG. 6 is a perspective view of a portion of the clamping device of FIG. 1, according to an exemplary embodiment.

FIG. 7 is a side view of a portion of the clamping device of FIG. 1, according to an exemplary embodiment.

FIG. 8 is a detailed side view of a portion of the clamping device of FIG. 1, according to an exemplary embodiment.

FIG. 9 is a perspective view of a portion of the clamping device of FIG. 1, according to an exemplary embodiment.

FIG. 10 is a side view of a portion of the clamping device of FIG. 1, according to an exemplary embodiment.

FIG. 11 is a detailed side view of a portion of the clamping device of FIG. 1, according to an exemplary embodiment.

### DETAILED DESCRIPTION

Referring generally to the figures, various embodiments of an actuating tool with a compound leverage system, the tool including opposing interfacing surfaces, such as a clamping device (e.g., pliers), bolt cutters, hand pruners, conduit benders, are shown. Pliers generally include interface elements and gripping elements, the gripping elements actuating the interface elements towards and away from each other. Compound pliers include a compound leverage system that optionally alters (e.g., increases) an amount of force exerted by the interface elements in response to moving the gripping elements.

Described herein are compound pliers including a first component and first jaw with a first plurality of teeth, and a second component coupled to a second jaw, the second component including a second plurality of teeth that interface with the first plurality of teeth. Applicant has observed that other compound pliers with interfacing teeth include a set of teeth separate from both handles. In other words, conventional compound pliers typically include a separate component, such as a pawl that attaches to the jaw or handle. In contrast, the various embodiments of the actuating tool discussed herein include a component such as a pawl integrated into the handle. By integrating both sets of teeth with the components and/or jaws, Applicant has observed that the pliers described herein are easier to manufacture and have the same or similar force-multiplying effects.

Referring to FIGS. 1-4, a clamping tool, shown as pliers 110, is shown according to an exemplary embodiment. Pliers 110 include a first jaw 120 coupled to a first component 130, such as rigidly coupled. First component 130 includes first neck section 132 coupled to first jaw 120, and first grip section 134 coupled to first neck section 132, such as being integrally formed. In various embodiments, first jaw 120 is integrally formed with first component 130. First component includes first plurality of teeth 136. Pliers 110 include a second jaw 150 coupled to a second component 160, such as pivotally coupled. Second component 160 includes second neck section 162 pivotally coupled to second jaw 150, and second grip section 164 coupled to second neck section 162, such as via being integrally formed. In various specific embodiments, the second component 160 and the second grip section 164 form a single, integral or unitary component.

First jaw 120 includes first interface portion 122 and second jaw 150 includes second interface portion 152. In a specific embodiment, first interface portion 122 is a first jaw face and second interface portion 152 is a second jaw face. In other embodiments, first interface portion 122 and second interface portion 152 are cutting blades and in such an embodiment, the actuating tool is a cutting tool such as bolt cutter, pruners, etc.). First interface portion 122 of first jaw 120 and second interface portion 152 of second jaw 150 actuate between an open configuration in which the first interface portion 122 and the second interface portion 152 are spaced apart, and a closed configuration in which the first interface portion 122 and the second interface portion 152 contact each other.

Pliers 110 extend along longitudinal axis 112 such that first interface portion 122 of first jaw 120 and second interface portion 152 of second jaw 150 are on opposite sides of longitudinal axis 112. In use, a user actuates first grip section 134 towards and/or away from second grip section 164 to actuate first interface portion 122 of first jaw 120 and second interface portion 152 of second jaw 150 towards and/or away from each other. In particular, second jaw 150 and second component 160 rotate about first rotational axis 114 with respect to first jaw 120 and first component 130. In various embodiments, first plurality of teeth 136 are radially centered on first rotational axis 114 and extend away from first rotational axis 114.

Second jaw 150 is pivotally coupled to second component 160 such that second jaw 150 pivotally rotates about second rotational axis 172 with respect to second component 160. Second rotational axis 172 is distinct from first rotational axis 114. In other words, second rotational axis 172 is not collinear with first rotational axis 114.

A biasing element, shown as spring 156, is coupled to second jaw 150 and second component 160 such that second jaw 150 and second component 160 move together. Spring 156 biases second component 160 in direction 175 about second rotational axis 172 such that second grip section 164 is biased away from first grip section 134 and first plurality of teeth 136 are biased away from second plurality of teeth 166. Stated another way, second jaw 150 and second component 160 move freely as a rigid body until an object such as a workpiece 190 is encountered by the jaws. Specifically, spring 156 biases a surface of second jaw 150 against a constraining or interfacing surface 161 of second component 160 when no external force is being exerted on second component (e.g., a user is not actuating the grip sections closer). Constraining surface 161 is at least partially a rearward facing surface (i.e., toward second grip section 164). When a user actuates the grip sections closer and the jaws close around an object and the user applies a force that overcomes the preload force from spring 156, the first plurality of teeth 136 engage with the second plurality of teeth 166, as will be explained below. In other words, constraining surface 161 limits the movement of second component relative to second jaw 150.

In practice, spring 156 applies a biasing force such that second jaw 150 interfaces against the constraining surface 161 of second component 160. The engagement between the second jaw 150 and constraining surface 161 resists movement of the second component 160 relative to the second jaw 150. In other words, spring 156 applies a biasing force pushing the second jaw 150 into engagement with constraining surface 161 of second component 160 to resist movement of second component 160 relative to second jaw 150. When second jaw 150 is engaged with constraining surface 161, the second component 160 and second jaw 150 move together like a rigid component.

When a grip force that is greater than the biasing force is applied to second grip section 164, the second component 160 moves relative to second jaw 150 such that the second plurality of teeth 166 disengage from the first plurality of teeth 136. When the second grip section 164 is released, the grip force is less than the biasing force such that the biasing force pushes the second plurality of teeth 166 so that the second plurality of teeth 166 disengage from the first plurality of teeth 136.

Referring to FIG. 1, when no external force is being exerted on pliers 110, second plurality of teeth 166 are not engaged with first plurality of teeth 136. In particular, spring 156 biases second grip section 164 away from first grip section 134 until the jaws (e.g., first interface portion 122 and second interface portion 152) encounter resistance.

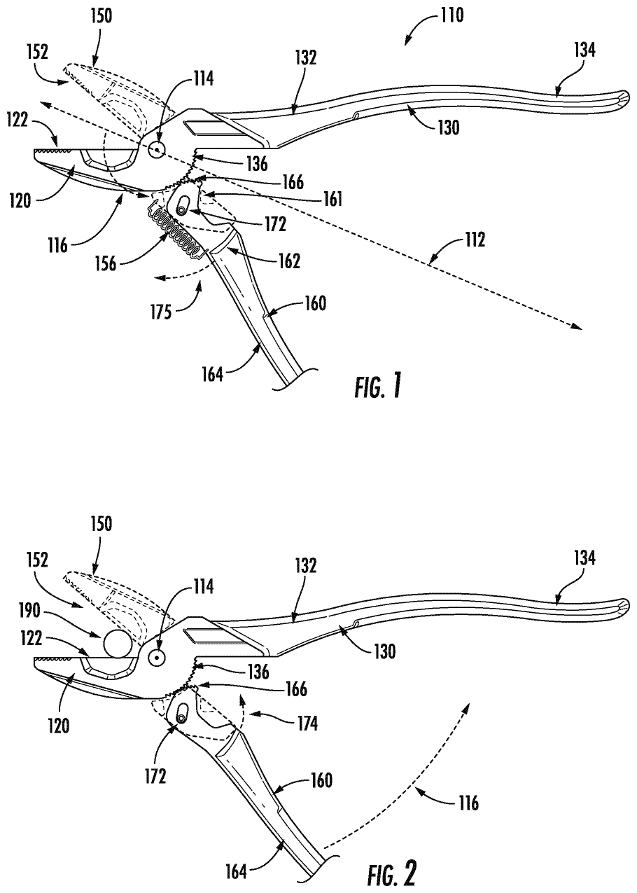

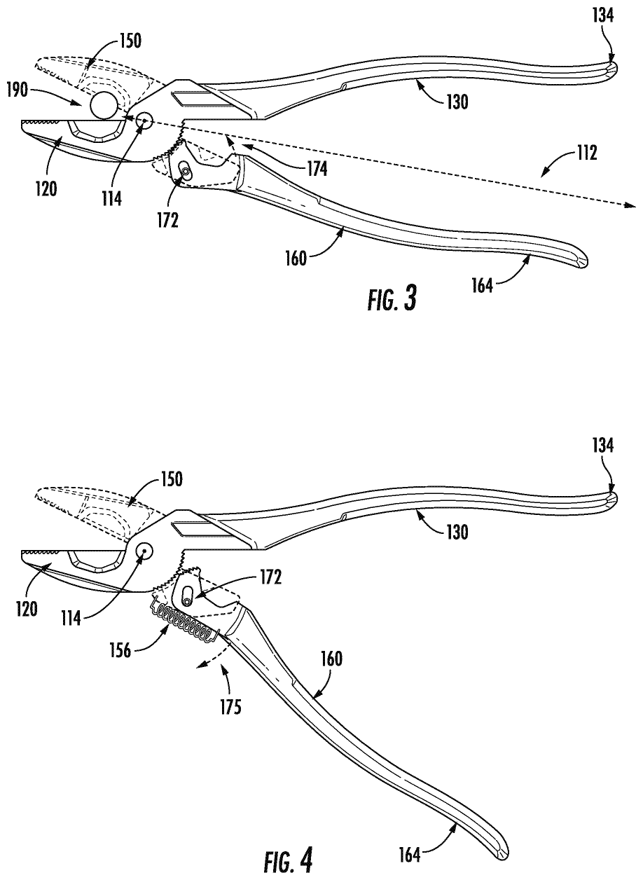

Referring to FIG. 2, in use a user rotates second grip section 164 towards first grip section 134 in direction 116 about first rotational axis 114 until first interface portion 122 and second interface portion 152 interface with an object, shown as workpiece 190. In various specific embodiments, second grip section 164 is rotated about 5 degrees (i.e., 5 degrees plus or minus 2 degrees). In other words, as an angle between longitudinal axis 112 and second grip section 164 is reduced, the space between the first plurality of teeth 136 and second plurality of teeth 166 is reduced.

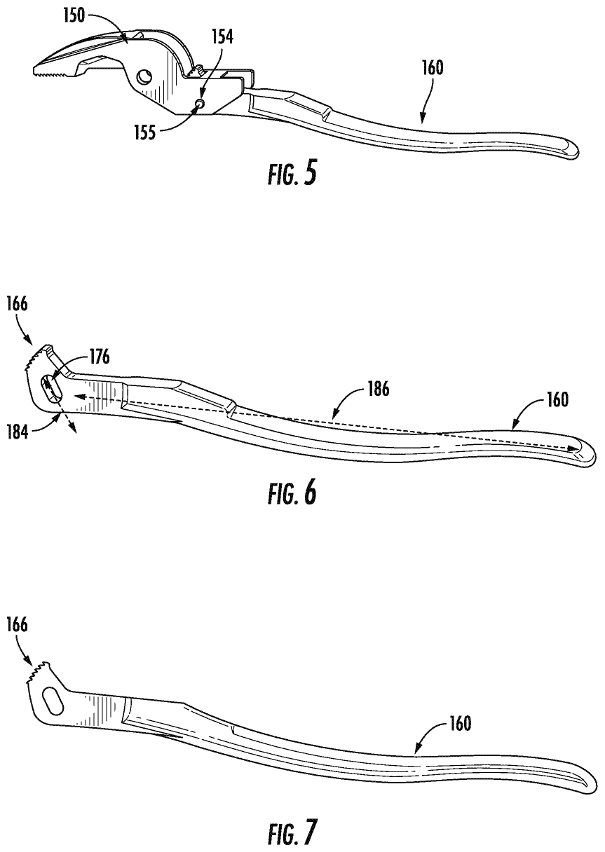

Subsequently, as continued force is exerted on second grip section 164 towards first grip section 134 overcomes the force exerted by spring 156 and results in second component 160 rotating in direction 174 about second rotational axis 172 with respect to second jaw 150 until second plurality of teeth 166 engage with first plurality of teeth 136 (FIG. 3), thereby resulting in a compound leverage system being exerted on first interface portion 122 and second interface portion 152. Stated another way, a user actuating the second grip section 164 towards the first grip section 134 results in the first plurality of teeth 136 engaging with the second plurality of teeth 166 such that a force and/or torque exerted on the workpiece 190 is increased. Referring to FIG. 4, when the user ceases forcing second grip section 164 towards first grip section 134, second component 160 rotates in direction 175 about second rotational axis 172 with respect to second jaw 150, thereby disengaging first teeth 136 and second teeth 166.

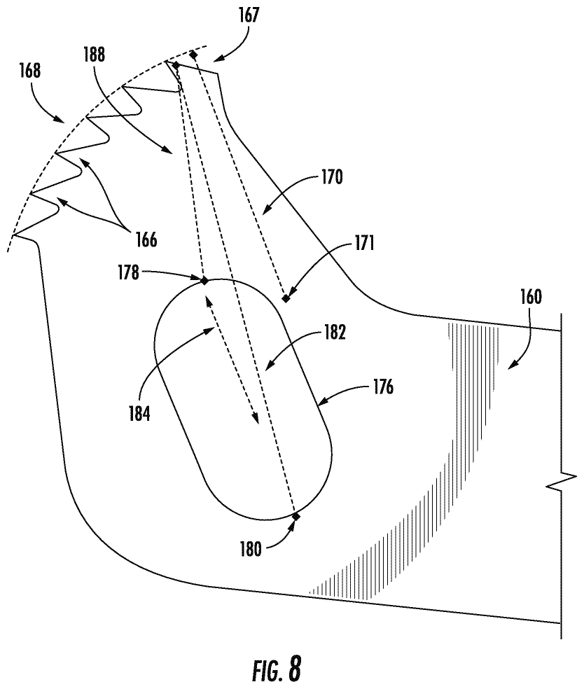

Referring to FIGS. 5-8, various aspects of second component 160 and second jaw 150 are shown. In various embodiments, second component 160 and second jaw 150 are pivotally coupled together. For example, an elongate structure, such as a pin 155, is extended through aperture 154 of second jaw 150 and elongate aperture or slot 176 of second component 160, thereby pivotally coupling second component 160 and second jaw 150. Elongate aperture 176 extends along a major or longitudinal axis 184 of elongate aperture 176, and second component 160 extends along a longitudinal axis 186. In a specific embodiment, longitudinal axis 184 of elongate aperture 176 is not collinear with longitudinal axis 186 of second component 160.

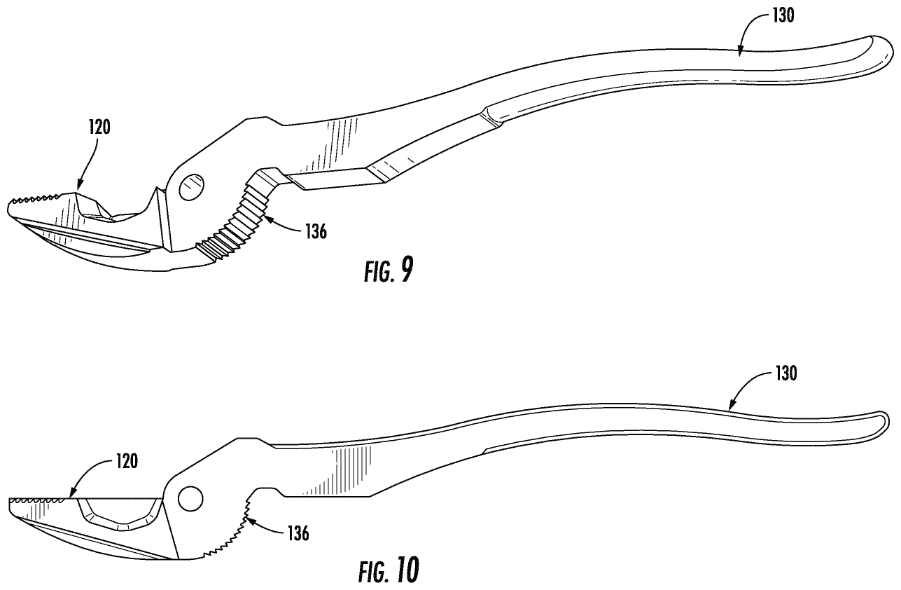

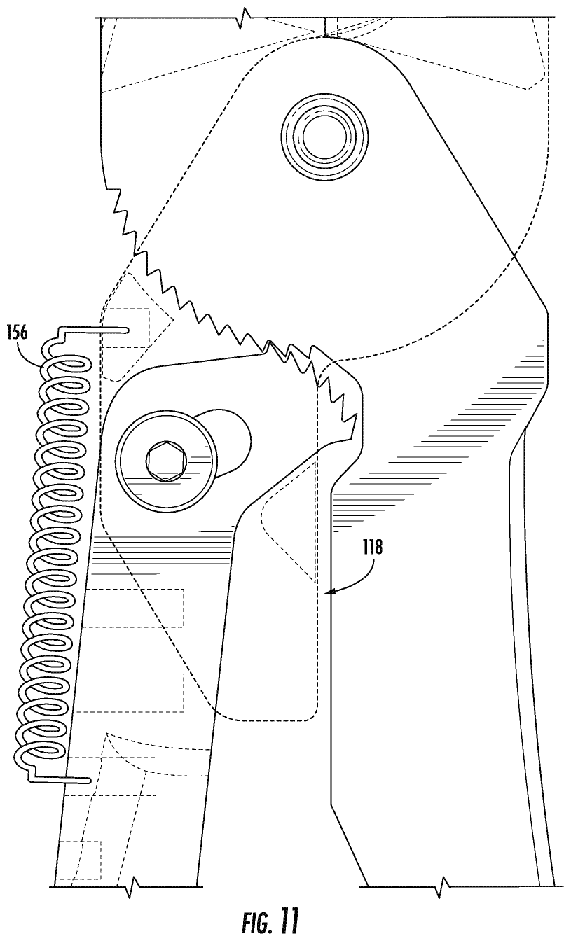

Referring to FIG. 8, elongate aperture 176 extends from a first end 178, closest to plurality of teeth 166, to an opposing second end 180, furthest from plurality of teeth 166. In various embodiments, plurality of teeth 166 define an outer surface 168 that is radially centered on point 171 via radius 170. In various embodiments, point 171 is not positioned within elongate aperture 176 of second component 160. In various embodiments, point 171 is not located within second component 160. Stated another way, outer surface 168 is non-concentric with respect to second rotational axis 172. Applicant has observed that outer surface 168 being non-concentric with respect to second rotational axis 172 increases the number of teeth interfacing between first plurality of teeth 136 and second plurality of teeth 166. In other words, the first plurality of teeth 136 and second plurality of teeth 166 are able to engage when torque is applied to the workpiece 190 rather than only single or half tooth engagement.

First end 178 is first distance 188 from the outer surface of first tooth 167 in plurality of teeth 166 (e.g., the tooth closest to first grip section 134 and positioned adjacent to longitudinal axis 112), and second end 180 is second distance 182 from the outer surface of first tooth 167. In various embodiments, radius 170 of outer surface 168 is greater than first distance 188 and less than second distance 182.

Referring to FIG. 11, in various embodiments, pliers 110 include a grip area 118, such as for pulling wires through a conduit.

In an alternative embodiment, second jaw 150 and second component 160 could be pivotally coupled together via a pin that nests in an open hook. In various embodiments, pliers 110 include an additional biasing element, such as a spring separate from spring 156, to bias first interface portion 122 away from second interface portion 152 and/or to bias first grip section 134 away from second grip section 164. In contrast to spring 156, such an additional spring specifically biases first grip section 134 away from second grip section 164.

In an alternative embodiment, first plurality of teeth 136 may be arranged to have a straight outer surface, rather than being curved. In an alternative embodiment, pliers include another biasing element that biases about second rotational axis 172.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. A pliers comprising:
a first jaw comprising a first interface portion;
a first component coupled to the first jaw, the first component comprising:
a first neck section coupled to the first jaw;
a first grip section extending from the first neck section; and
a first plurality of teeth extending from the first neck section away from the first jaw;
a second jaw pivotally coupled to the first jaw and rotatable with respect to the first jaw about a first rotational axis, the second jaw comprising:
a second interface portion, the second interface portion facing toward the first interface portion and on an opposing side of a longitudinal axis from the first interface portion;
a second component comprising:
a second neck section pivotally coupled to the second jaw;
a second grip section extending from the second neck section; and
a second plurality of teeth extending outward from the second neck section, wherein the second jaw pivotally rotates with respect to the second component about a second rotational axis distinct from the first rotational axis; and
a biasing element coupled to the second component and the second jaw such that the second jaw is moved with the second component;
wherein the first jaw and the second jaw actuate between an open position in which the first interface portion and the second interface portion are spaced apart, and a closed position in which the first interface portion contacts the second interface portion; and
wherein, when the second grip section is actuated towards the first grip section, the first plurality of teeth engage the second plurality of teeth.

2. The pliers of claim 1, further comprising an elongate structure, the second component comprising a first elongate aperture, and the second jaw comprising a second aperture, wherein the elongate structure extends through the first elongate aperture and the second aperture thereby coupling the second component and the second jaw, such that the second component is slidable and pivotally rotatable with respect to the second jaw.

3. The pliers of claim 2, the first elongate aperture extending from a first end adjacent to the second plurality of teeth to a second end opposing the first end, wherein the second plurality of teeth comprise an outer surface positioned along a curve, and wherein the curve defines a radius that is centered on a point that is not positioned within the first elongate aperture.

4. The pliers of claim 3, wherein the first elongate aperture defines a first distance from the first end of the first elongate aperture to a first tooth of the second plurality of teeth, the first tooth positioned adjacent to the longitudinal axis, and a second distance defined from the second end of the first elongate aperture to the first tooth of the second plurality of teeth.

5. The pliers of claim 4, wherein the radius of the curve defines a third distance, and wherein the third distance is greater than the first distance.

6. The pliers of claim 5, wherein the third distance is less than the second distance.

7. The pliers of claim 1, wherein the second component and the second grip section form a single, integral component.

8. The pliers of claim 1, wherein the biasing element applies a biasing force such that the second jaw interfaces against a constraining surface of the second component, wherein engagement between the second jaw and the constraining surface resists movement of the second component relative to the second jaw.

9. A clamping tool comprising:
a first jaw comprising a first jaw face;
a first component coupled to the first jaw, the first component comprising:
a first neck section coupled to the first jaw;
a first grip section extending from the first neck section; and
a first plurality of teeth extending from the first neck section;
a second jaw pivotally coupled to the first jaw and rotating with respect to the first jaw about a first rotational axis, the second jaw comprising:
a second jaw face, the second jaw face positioned on an opposing side of a longitudinal axis from the first jaw face;
a second component comprising:
a second neck section pivotally coupled to the second jaw;
a second grip section extending from the second neck section; and
a second plurality of teeth extending from the second neck section, wherein the second jaw pivotally rotates with respect to the second component about a second rotational axis; and
a biasing element coupled to the second component and the second jaw such that the second jaw and the second component move together;
wherein, when the first jaw face and second jaw face are spaced apart, the first plurality of teeth are disengaged from the second plurality of teeth; and
wherein, when the second grip section is rotated toward the longitudinal axis and the first jaw face and the second jaw face engage a workpiece, the first plurality of teeth engage the second plurality of teeth as a torque is applied to the workpiece.

10. The clamping tool of claim 9, wherein, when the second grip section is rotated away from the longitudinal axis, the biasing element moves the second component away from the longitudinal axis such that the first plurality of teeth disengage from the second plurality of teeth.

11. The clamping tool of claim 9, further comprising a pin extending through a slot of the second component and an aperture of the second jaw coupling the second component to the second jaw.

12. The clamping tool of claim 11, wherein the second component is slidable and pivotally rotatable with respect to the second jaw.

13. The clamping tool of claim 9, wherein the biasing element applies a biasing force moving the second jaw into engagement with a constraining surface of the second component such that second component and the second jaw move together like a rigid component.

14. The clamping tool of claim 13, wherein, when a grip force is applied to the second grip section and the grip force is greater than the biasing force, the second component moves relative to the second jaw such that the second plurality of teeth engage the first plurality of teeth.

15. The clamping tool of claim 9, wherein the second component and the second grip section form a single, integral component.

16. The clamping tool of claim 9, wherein the second rotational axis is not collinear with the first rotational axis.

17. A pliers comprising:
a first jaw comprising a first interface portion;
a first component coupled to the first jaw, the first component comprising:
a first neck section coupled to the first jaw;
a first grip section extending from the first neck section; and
a first plurality of teeth extending from the first neck section away from the first jaw;
a second jaw pivotally coupled to the first jaw and rotatable with respect to the first jaw about a first rotational axis, the second jaw comprising:
a second interface portion, the second interface portion facing toward the first interface portion;
a second component comprising:
a second neck section pivotally coupled to the second jaw;
a second grip section extending from the second neck section;
a constraining surface facing toward the second grip section; and
a second plurality of teeth extending from the second neck section, wherein the second jaw pivotally rotates with respect to the second component about a second rotational axis; and
a spring coupled to the second component and the second jaw;
wherein the spring applies a biasing force pushing the second jaw into engagement with the constraining surface of the second component to resist movement of the second component relative to the second jaw.

18. The pliers of claim 17, wherein, when a grip force that is greater than the biasing force is applied to the second grip section, the second component moves relative to the second jaw such that the second plurality of teeth engage the first plurality of teeth.

19. The pliers of claim 18, wherein, when the second grip section is released, the grip force is less than the biasing force and the biasing force pushes the second plurality of teeth such that the second plurality of teeth disengage from the first plurality of teeth.

20. The pliers of claim 17, further comprising a pin extending through a slot of the second component and an aperture of the second jaw coupling the second component to the second jaw, wherein the second component is slidable and pivotally rotatable with respect to the second jaw.
